(19) United States
(12) Patent Application Publication
(10) Pub. No.: US 2010/0064132 A1
(43) Pub. Date: Mar. 11, 2010

(54) METHOD AND SYSTEM FOR CLOSE RANGE COMMUNICATION USING CONCENTRIC ARCS MODEL

(76) Inventor: Pasupuleti Ravikiran Sureshbabu, Chennai (IN)

Correspondence Address: ALIX YALE & RISTAS LLP, 750 MAIN STREET, SUITE 1400, HARTFORD, CT, 06103, US

(21) Appl. No.: 12/528,356

(22) PCT Filed: Feb. 19, 2008
(86) PCT No.: PCT/IN08/00097

§ 371 Date: Aug. 24, 2009

(30) Foreign Application Priority Data
Feb. 23, 2007 (IN) 375/CHE/2007

(51) Int. Cl. H04L 9/00; H04B 5/00; H04L 9/30

(52) U.S. Cl. 713/153; 455/41.1; 380/30

(57) ABSTRACT

The present invention relates to a method and system for close range communication involving colored images preferably involving concentric circles and/or arcs as coloured image based information identifiers. More particularly, the invention is directed to a method and system to communicate information between two mobile phones using the display (Screen) and Capturing units (Camera) of the mobile devices.

### FIELD OF INVENTION

The present invention relates to a method and system for close range communication involving colored images preferably involving concentric circles and/or arcs as colored image based information identifiers. More particularly, the invention is directed to a method and system to communicate information between two mobile phones using the display (Screen) and capturing units (Camera) of the mobile devices. The communication may be for a transactional purpose or otherwise. The method and the system of the invention is thus adapted preferably for transmitting an identity information from one electronic device to another through NFC (near field communication). The image identity information being achieved involving colored images such as number of concentric arc statically displayed on a mobile phone screen so that it can be used by another image capturing device to interpret the static data represented by the image.

### BACKGROUND ART

It is well known in the prior art that presently available methods of transactions often involve acquisition of goods and services with retailers and distributors either by traveling personally to the retail/supplier of desired goods/services for a face-to-face interaction and transact goods/services either in exchange of cash or cheque, or by credit card, or by any suitable electronic transfer of funds. While a cash transaction is apparently secure and tangible in nature, the process of handling and carrying the cash to the retailer's place of business and of transporting purchased goods back to their place of use or storage often may not be safe and secure. Paper money can be forged, cheques can be misappropriated and fraudulently passed, credit cards can be misappropriated and fraudulently used, and electronic funds transfer may be vulnerable to errors and to electronic theft.

Other method of transactions involves using telephones as medium of communicating between the parties involved in any such transactions. Many of the above-described risks for face-to-face transactions are avoided by using the telephone as a medium for commerce. A telephone transaction may be much more efficient with regard to time and costs associated with communications than traveling personally to a retailer's place of business. It helps avoiding inherent risks of traveling and carrying cash. However, telephone communications are uncontrollably unsafe and unsecured due to the lack of proper recording of events and interceptions/distortions due to barriers in communication, either semantic or in the form of noise. Thus telephone communications are notoriously insecure and while improved devices may direct to telephone transactions requiring less staffing and facilities overhead, as compared to a retailer, such transactions still require either human operators or relatively time-inefficient, cumbersome, and often annoying voice menu systems and recorded-voice order-entry systems.

Alternatively, transactions in e-commerce mode through the Internet are relatively a recent phenomenon. As the Internet has emerged to become one of the fastest growing and technologically most sophisticated medium, it is popularly accepted by many for ordering goods/services they need. An Internet user can quickly conduct a comparative analysis of products, identify retailers and distributors for those products, place orders through relatively easy mouse and keyboard input, and pay for the transactions using relatively secure encrypted communications for the exchange of credit card information and other types of electronic funds transfer. The internet provides a communication medium much richer in contents than the telephone by providing the display of graphical information as well as text-based and sound-based information. However, the major limitation of the Internet is that a user generally requires a personal computer to access the network. Also, the personal computers are relatively expensive/costly item to maintain over time, inconvenient to carry and the use of credit cards for online payments over internet is found to frequently suffer from misuse for fraudulent purposes, use of this medium is not acceptable for cash intensive transactions without adequate security.

In the case of mobile or telephones, recent practices have shown “cloning” cellular telephone, which entails intercepting telephone transmissions from a cellular telephone, to another cellular phone. Such “cloned” telephones are typically sold on the ‘secondary’/“black” market. In these instances, the cellular telephone owner has no way of knowing whether, or when, his or her cellular transmissions are being intercepted and/or if and when a “cloned” cellular phone is created and/or is utilized on, or over, his or her cellular telephone account making it very dangerous for any kind of transactions via a mobile/cellular phone. At present, there is no apparatus or method for preventing such unauthorized use.

It is also known in the art that there are various systems developed over the years to control telephones using computer systems to make calls, send SMS's etc. such as those disclosed in U.S. Pat. No. 7,162,259, U.S. Pat. No. 7,162,269 and U.S. Pat. No. 7,162,222.

U.S. Pat. No. 7,143,091 is directed to a method and apparatus for sociological data mining which relates to document identification among a group of documents but does not address to any identity information from one electronic device to another through NFC (near field communication).

U.S. Pat. No. 4,475,465 titled ‘Transaction security system and modular transaction processing center’ is directed to providing physical security for transaction processing areas in banks etc. but is not applicable for identity transmission between two devices such as mobile phones and the like.

It is also known in the art to provide for systems which could detect the presence of an electronic apparatus by another electronic apparatus such as the US 2005267876. However, there is no direction for secured information transaction between two devices such as mobile phones and the like.

WO2004068301 is a published international application titled ‘Network-based systems, methods, and software for initiating or executing financial transactions’. This prior art is directed to large trade platform software to represent huge amounts of data in the form of heat maps and color maps to dynamically show the areas of concentration of activity.

It would be clearly apparent from the above that while cellular network based communication including computer controlled network communications are known and even systems for identify devices in a network/range are also disclosed in the art, there has been thus a continuous need for achieving the transmitting of an identity information from one electronic device to another through NFC (near field communication), for making a transaction using mobile/cellular devices, which shall be secured and which over comes the difficulties of the presently available cellular/e-transactions described in the prior art, such as the unauthorized interception or misappropriation of on-line fund transaction fraudulently. Importantly, there is a need in the art for a method for safe and secured transaction of message/communication among communication transmission devices more particularly providing for a secured method and system for communicating by using mobile phones for making a transaction.

### OBJECTS OF THE INVENTION

It is thus the basic object of the present invention to provide for a secured method and system for communicating over a mobile phone for making a transaction and a system to carry out such method.

A further object of the present invention is directed to a safe and secured method and system for close range communication involving colored images such as with concentric circles or arcs through a display and an image-capturing device.

A further object of the present invention is directed to a method and system to communicate information in a safe and secured manner between at least two mobile phones wherein the system includes mobile devices having display (Screen) and Capturing units (Camera) for the desired communication for transactional purposes and the like.

A still further object of the present invention is directed to a method and system adapted to support public/private key encryption mechanism to ensure security of communication/transaction.

A still further object of the present invention object of the present invention is directed to a method and system having platform independent communication.

Yet another object of the present invention is to provide for a method and system wherein the amount of information communicated can be in the order of 10 to 50 bytes, depending on the size of the display device, the optimal color spread required and the resolution of the capturing device.

A still further object of the present invention is directed to a new method and system for information transaction such as required for close range exchange of identity information, device based authentication in consumer solutions and Mobile commerce.

### SUMMARY OF THE INVENTION

Thus according to the basic aspect of the present invention there is provided a method for colored image based close range communication of information comprising colored images of concentric circles and/or arcs wherein each color represents a byte of information wherein said colored concentric circles and/or arcs based encrypted bit information are generated for the secured communication and received and decrypted for secured communication of the information through said colored images.

According to a preferred aspect the method for colored image based close range communication of information comprises:

generating said colored concentric circles and/or arcs based encrypted bit information for the secured communication by means of atleast one relatively mobile information generating devices;
receiving the said colored concentric circles and/or arcs based encrypted bit information and decrypting the same in atleast one relatively mobile information receiving device; and
said generation and receipt of information being carried out via a central server maintained in operative communication between said relatively mobile information generating devices and relatively mobile information receiving device.

In the above method for colored image based close range communication of information the colored concentric circles and/or arcs based encrypted bit information comprise information about the said relatively mobile information generating device. Depending on the size of information being exchanged, colored concentric arcs (for more info) or colored concentric circles (for lesser info) are used.

Advantageously, in the method for colored image based close range communication of information according to the invention the images of the said concentric circles and arcs in the said relatively mobile information generating device are captured by the relatively mobile information receiving device for the said information communication.

Importantly, the method for colored image based close range communication of information further comprises carrying out validation checks of the information communicated between the said relatively mobile information generating device and the relatively mobile information receiving device through said operative central server connection, said images having built in error correction mechanisms with data repeating as similar colored arcs in multiple regions.

In accordance with a preferred aspect the method comprises better error recovery by interleaving the content bands (data+FEC) such that capturing skew can be averages and a more accurate data can be transmitted.

The amount of information communicated is based on the size of the display device, optimal color spread required and the resolution of the capturing device.

The method favours selectively close range exchange of identity information, device based authentication in consumer solutions and mobile commerce.

In accordance with another aspect of the invention there is provided a system for colored image based close range secured communication of information using colored images of concentric circles and/or arcs wherein each color represents a byte of information comprising:
(a) atleast two or more mobile phones/wired devices each having a display and image-capturing device;
(b) means for generating said colored concentric circles and/or arcs based encrypted bit information for the secured communication by means of atleast one relatively mobile information generating devices;
(c) means for receiving the said colored concentric circles and/or arcs based encrypted bit information and decrypting the same in atleast one relatively mobile information receiving devices; and
(d) a central server means adapted for operative communication between said generated and received image based information between said relatively mobile information generating devices and relatively mobile information receiving devices.

In accordance with a preferred aspect of the invention the central server generates a unique sequence number (basic unit) valid for a one time use by a client application and associating it with a single client application.

Also the said central application would internally store an encrypted value which would be multiples of a basic unit.

In accordance with a preferred aspect of the invention the said colored concentric circles and/or arcs based encrypted bit information and decrypting the same are received using a merchant application.

In accordance with a preferred aspect of the invention the colored concentric circles and/or arcs based encrypted bit information comprise information about the said relatively mobile information generating device.

Advantageously, the images generated and received are adapted depending on the size of information being exchanged, colored concentric arcs (for more info) or colored concentric circles (for lesser info) are used.

Also the said relatively mobile information receiving device for the said information communication is adapted to capture the images of the said concentric circles and arcs generated in the said relatively mobile information generating device.

In accordance with a further aspect of the invention, the system for colored image based close range communication of information comprises said server means adapted to carry out validation checks of the information communicated between the said relatively mobile information generating device and the relatively mobile information receiving device, said images having built in error correction mechanisms with data repeating as similar colored arcs in multiple regions.

Advantageously, the above system includes means for error recovery comprising provision for interleaving the content bands (Data+FEC) such that capturing skew can be averaged and a more accurate data can be transmitted.

Preferably the system includes means adapted to support public/private key encryption mechanism.

Advantageously also the system for colored image based close range communication of information favours platform independent communication.

The system for colored image based close range communication of information is thus adapted to communicate information in the order of 10 to 50 bytes, depending on the size of the display device, optimal color spread required and the resolution of the capturing device.

According to another aspect the system for colored image based close range communication of information comprises selectively means for (i) simple concentric circles based color images free of any encryption or error correction or (ii) concentric arcs model with built in forward error correction and encryption bands.

Thus the above disclosed system for colored image based close range communication of information is adapted for close range exchange of identity information, device based authentication in consumer solutions and mobile commerce.

### BRIEF DESCRIPTION OF THE ACCOMPANYING FIGURES

FIG. 1: is an illustration of a simple concentric circles based approach, without any encryption or error correction method.

FIG. 2: is an illustration of a concentric arcs model, with built in forward error correction and encryption bands.

FIG. 3: is an illustration of the manner of secured colored image based encrypted transmission of information; and

FIG. 4: is an illustration of the manner of colored image based receipt and decryption of the transmitted colored image based information of the invention.

### DETAILED DESCRIPTION OF THE INVENTION WITH REFERENCE TO THE ACCOMPANYING FIGURES

As already described, the present invention is directed to a method of close range communication using colored images with concentric circles or arcs and more particularly, a method to communicate information between two mobile phones using system for implementing said method comprising the display (Screen) and Capturing units (Camera) of the mobile devices.

The present invention is further directed to make use of most preferably the colored concentric circles and arcs, where each color represents a byte of information.

Advantageously, the method of close range communication according to the present invention comprising display and capturing image as identity transmission for secured transaction over mobile/cellular devices, is directed to provide better error recovery by interleaving the content bands (Data+FEC) so that capturing skew can be averaged and a more accurate data can be transmitted.

The method according to the present invention further supports public/private key encryption mechanism, to ensure identity communication or transactions, in safe and secured manner without the possibility of unauthorized interception during transaction between two devices. Moreover, the secured transaction of identity or confidential contents of the invention, takes place in a platform independent manner of communication. The method of the invention thus ensure elimination of misappropriation and fraudulent interception during electronic funds transfer while transmitting over mobile devices that is otherwise vulnerable to errors or to electronic theft.

The method of identity communication or transaction according to the present invention using a system comprising mobile/cellular devices wherein the amount of information that can be communicated is in the order of 10 to 50 bytes, depending on the size of the display device such as the mobile screen, the optimal color spread required and the resolution of the capturing device.

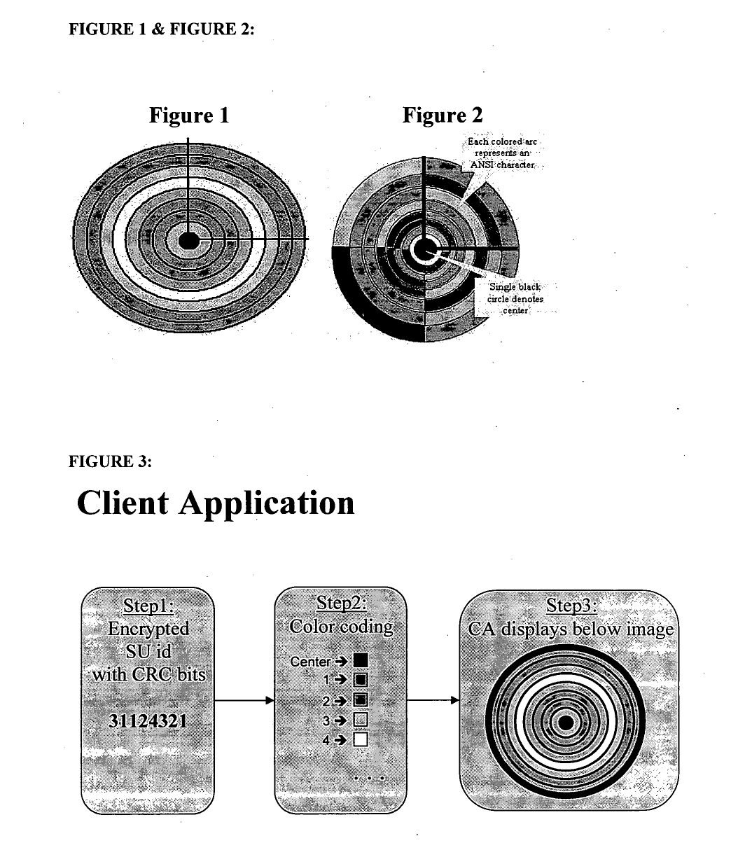

Reference is first invited to the accompanying FIG. 1 that illustrates an embodiment of the invention involving a simple concentric circles based approach. Thus the image representing information for communication/transaction in such a system, the transmission of information/identity is not much accurate without any encryption or error correction method, although in a secured manner.

Reference is next invited to the accompanying FIG. 2 which is the illustration of a concentric arcs model according to the invention, with built in forward error and correction encryption bands. The embodiment of this type provides display and capturing colored image for identity transmission or for transaction, as much secure and error free accurate communication means between two mobile devices, wherein each colored arc represents an ANSI character and single black circle denotes center. Moreover, such an embodiment provide better error recovery by interleaving the content bands (Data+FEC) so that capturing skew can be averaged and a more accurate data can be transmitted, ensuring secured transaction, the amount of information being up to a maximum of 50 bytes, depending on the size of the display device such as the mobile screen, the optimal color spread required and the resolution of the capturing device.

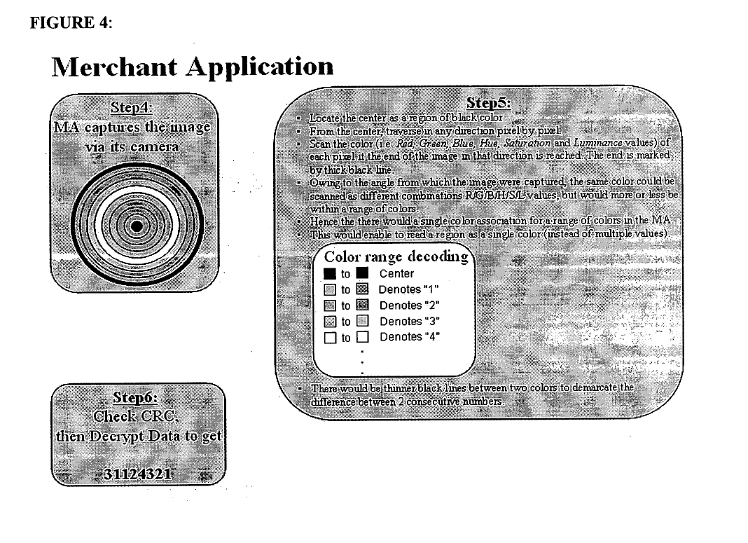

Reference is now invited to accompanying FIGS. 3 and 4 for further illustration of an exemplary illustration of the manner of secured communication of the information using the above method and system of the invention.

As clearly illustrated in FIG. 3, the initiating side (consumer) would have a mobile device containing an application—referred to as Consumer Application (CA). The fulfillment side (merchant) shown in FIG. 4 would have another mobile/wired device containing another application—referred to as Merchant Application (MA).

The CA would internally store an encrypted value which would be multiples of a basic unit called System Unit (SU). A Central Server (CS) generates a SU and associates it with a single CA, at any given point of time. An SU is a unique sequence number valid for a onetime use by a CA. Once used, the SU is associated with a different CA or an MA. Usage (of SU) means, performing a transaction in the system between a CA and another CA or MA. Transaction is performed in the system by transmitting/receiving/exchanging concentric circles and/or arcs. An SU is valid only in the system it is being used, which is controlled by its CS. Each system would have its own CS. An SU is NOT an identity of a CA or MA, but denotes a certain temporary value being held within a CA or MA of the system.

A system such illustrated above can be owned by a physical authority, which could be any enterprise body like a financial institution, (say bank), loyalty management company, telecom company, retailer etc. A consumer signs up in a system and is created as a valid user in the system's Central Server (CS). The consumer's account can now hold a few SUs (based on the initial terms of account creation or if the consumer wishes to deposit SUs). Consumer can deposit SU's in his account by exchanging monetary units in a prepaid/postpaid form as agreed in the terms of account creation with the owner of the system. Consumer would then need to install the Client Application (CA), which can be downloaded from the CS. The consumer also needs to get from CS, the authentication details for using the CA. The CA has the capability to get the SU's (identified by the SU numbers) from the consumer's account in the CS. The owner of the system defines the valid merchants where the SU's are accepted.

All such merchants in the system need to install the Merchant Application (MA), which can be downloaded from the CS. The merchants also need to get from CS, the authentication details for using the MA. A consumer then walks into a valid merchant's location with mobile device and wishes to perform a transaction with the merchant.

The consumer invokes the CA in his mobile device by providing his authentication details. Similarly, the merchant invokes the MA in his mobile/wired device by providing his authentication details. The consumer device's screen is kept in an approximate orientation closer to the merchant device, so that the merchant device's image capturing unit (camera) can be in the line of sight of the consumer's display unit. Based on the available SU's in the CA, the consumer initiates the transaction by invoking a function in the CA. The CA's screen displays a colored concentric arcs image, representing the CA and SU numbers (encrypted). The image has built in error correction mechanisms with data repeating as similar colored arcs in multiple regions.

Depending on the size of information being exchanged, colored concentric arcs (for more info) or colored concentric circles (for lesser info) would be used by the CA and MA.

The merchant invokes a function in MA to capture the image that the CA displays on the consumer device's screen. Once the MA receives a valid image (with built-in CRC checks), the MA id, CA id and the SU number are sent over a telecom network by the MA to the CS. The CS validates the association of the SU with the CA and authenticates the transaction if such an association exists. Otherwise the CS rejects the authentication request. If the transaction is authenticated, the CS changes the association of the SU from the CA's account to MA's account. And if the transaction is rejected, no changes are done by the CS. Once the MA receives the authenticated response, he assumes the SUs to be valid and completes the transaction by delivery of goods.

This invention is based on the model where the consumer need not directly bear the cost of transaction, as it happens in a localized fashion between the consumer and the merchant, instead of the consumer transacting over an telecom network. The merchant however requires a telecom network to validate the transaction request.

This reduces the entry barriers and consumer's psychological resistance towards adopting the system, as it does not try to change the current consumer behaviour in performing a transaction. The invention can be applied to loyalty promotions, coupons, financial transactions etc.

It is thus possible by way of this invention to provide a method of close range communication according to the present invention comprising display and capturing colored image comprising concentric circles and arcs as identity transmission for secured transaction or other purposes, using a system comprising mobile/cellular devices through NFC (near field communication), and the invention is thus adapted to be applied in various fields comprising close range exchange of identity information, device based authentication in consumer solutions, Mobile commerce and the like.

1-22. (canceled)

23. A system for colored image-based close range secured communication of information using colored images of concentric circles and/or arcs wherein each color represents a byte of information comprising:
(a) at least two or more mobile phones or wired devices each having a display and image-capturing device;
(b) means for generating said colored concentric circles and/or arcs-based encrypted bit information for the secured communication by means of at least one relatively mobile information generating devices;
(c) means for receiving the said colored concentric circles and/or arcs-based encrypted bit information and decrypting the same in at least one relatively mobile information receiving device; and
(d) a central server means adapted for operative communication between said generated and received image-based information between said relatively mobile information-generating devices and relatively mobile information-receiving devices.

24. A system for colored image-based close range secured communication of information according to claim 23 wherein the central server generates a unique sequence number (basic unit) valid for a one time use by a client application and associates said unique sequence number with a single client application.

25. A system for colored image-based close range secured communication of information according to claim 24 wherein the central application would internally store an encrypted value which would be multiples of a basic unit.

26. A system for colored image-based close range secured communication of information according to claim 23 wherein said colored concentric circles and/or arcs-based encrypted bit information and decryption thereof are received using a merchant application.

27. A system for colored image-based close range secured communication of information according to claim 23 wherein the colored concentric circles and/or arcs-based encrypted bit information comprises information about the said relatively mobile information generating device.

28. A system for colored image-based close range secured communication of information according to claim 27 wherein the images generated and received are adapted depending on the size of information being exchanged, wherein colored concentric arcs are used for more information and colored concentric circles are used for less information.

29. A system for colored image-based close range secured communication of information according to claim 28 wherein the said relatively mobile information receiving device for the said information communication is adapted to capture the images of the said concentric circles and arcs generated in the said relatively mobile information generating device.

30. A system for colored image-based close range secured communication of information according to claim 29 wherein said server means is adapted to carry out validation checks of the information communicated between the said relatively mobile information generating device and the relatively mobile information receiving device, said images having built in error correction mechanisms with data repeating as similar colored arcs in multiple regions.

31. A system for colored image-based close range secured communication of information according to claim 30 comprising means for error recovery comprising a provision for interleaving the content bands (Data+FEC) such that a capturing screw can be averaged and more accurate data can be transmitted.

32. A system for colored image-based close range secured communication of information according to claim 31 comprising means adapted to support a public or private key encryption mechanism.

33. A system for colored image-based close range secured communication of information according to claim 32 comprising platform independent communication.

34. A system for colored image-based close range secured communication of information according to claim 33 adapted to communicate information in the order of 10 to 50 bytes, depending on the size of the display device, optimal color spread required and the resolution of the capturing device.

35. A system for colored image-based close range secured communication of information according to claim 34 comprising selective means for (i) simple concentric circles based color images free of any encryption or error correction or (ii) concentric arcs model with built in forward error correction and encryption bands.

36. A system for colored image-based close range secured communication of information according to claim 35 adapted for close range exchange of identity information, device based authentication in consumer solutions and mobile commerce.
